(19) United States
(12) Patent Application Publication
(10) Pub. No.: US 2022/0287154 A1
(43) Pub. Date: Sep. 8, 2022

(54) HONEYCOMB STRUCTURE, ELECTRICALLY HEATING SUPPORT AND EXHAUST GAS PURIFYING DEVICE

(71) Applicant: NGK INSULATORS, LTD., Nagoya-City (JP)

(72) Inventors: Yukiharu MORITA, Nagoya-City (JP); Takayuki INOUE, Nagoya-City (JP); Naoki OKAMOTO, Nagoya-City (JP)

(73) Assignee: NGK INSULATORS, LTD., Nagoya-City (JP)

(21) Appl. No.: 17/455,700

(22) Filed: Nov. 19, 2021

(30) Foreign Application Priority Data
Mar. 3, 2021 (JP) 2021-033851
Sep. 15, 2021 (JP) 2021-150525

(51) Int. Cl. H05B 3/03; B01D 53/94; B01J 35/04

(52) U.S. Cl. CPC H05B 3/03; B01D 53/94; B01J 35/04

(57) ABSTRACT

A honeycomb structure 20 according to the present invention includes: a honeycomb structure portion 10 including: an outer peripheral wall 12; a partition wall 13 arranged on an inner side of the outer peripheral wall 12, the partition wall 13 defining a plurality of cells 16 each extending from one end face to other end face to form a flow path; and a pair of electrode layers 14a, 14b arranged on a surface of the outer peripheral wall 12 of the honeycomb structure portion 10, the pair of electrode layers 14 being provided so as to face each other across a central axis of the honeycomb structure portion 10. The honeycomb structure portion 10 is made of ceramics having an NTC property, and the pair of electrode layers are made of a material having a PTC property.

### FIELD OF THE INVENTION

The present invention relates to a honeycomb structure, an electrically heating support and an exhaust gas purifying device.

### BACKGROUND OF THE INVENTION

Patent Literature 1 as described below proposes the use of a honeycomb structure as an electrically heating support. The honeycomb structure includes: a cylindrical honeycomb structure portion having a porous partition wall defining a plurality of cells and an outer peripheral wall; and a pair of electrode portions arranged on a side surface of the honeycomb structure portion, wherein the honeycomb structure is configured to function as a catalyst support and also as a heater by applying a voltage. The partition wall and the outer peripheral wall are mainly based on a silicon-silicon carbide composite or silicon carbide, and the electrode portions are mainly based on silicon carbide particles and silicon.

For example, as disclosed in Patent Literature 2 below, it is known that silicon carbide has a property of decreasing electrical resistance (NTC property) as the temperature increases. The honeycomb structure disclosed in Patent Literature 1 contains silicon carbide in the honeycomb structure portion and the electrode portions, and has the NTC property.

### CITATION LIST

### Patent Literatures

[Patent Literature 1] WO 2011/125815 A1
[Patent Literature 2] Japanese Patent Application Publication No. H07-89764 A

### SUMMARY OF THE INVENTION

In an electrically heating support that functions as a heater by applying a voltage, it is not desirable that electrical resistance varies due to temperature changes from the viewpoint of temperature control of the electrically heating support. On the other hand, if the variation in the electrical resistance due to temperature changes is lower, it is easier to control the voltage and current applied for temperature control. If a decrease in electrical resistance as the temperature of the electrically heating support increases is larger, the current more easily flows and a temperature of the electrically heating support may rapidly increase. In particular, the use of the honeycomb structure having the NTC property decreases the electrical resistance as the temperature of the honeycomb structure increases, so that an excessive current partially flows, resulting in a rapid temperature increase.

The present invention was made in view of the above problems. One of objects of the present invention is to provide a honeycomb structure, an electrically heating support, and an exhaust gas purifying device, which can reduce a decrease in electrical resistance upon an increase in a temperature, can easily apply a constant electric power over time, and can suppress a rapidly increase in the temperature.

A honeycomb structure according to an embodiment of the present invention comprises: a honeycomb structure portion including: an outer peripheral wall; a partition wall arranged on an inner side of the outer peripheral wall, the partition wall defining a plurality of cells each extending from one end face to other end face to form a flow path; and a pair of electrode layers arranged on a surface of the outer peripheral wall of the honeycomb structure portion, the pair of electrode layers being provided so as to face each other across a central axis of the honeycomb structure portion, wherein the honeycomb structure portion comprises ceramics having an NTC property, and the pair of electrode layers comprise a material having a PTC property.

An electrically heating support according to an embodiment of the present invention comprises: the honeycomb structure described above; and electrode terminals electrically connected onto the pair of electrode layers of the honeycomb structure.

An exhaust gas purifying device according to an embodiment of the present invention comprises: the electrically heating support as described above; and a can body for holding the electrically heating support.

According to the honeycomb structure, the electrically heating support, and the exhaust gas purifying device according to an embodiment of the present invention, the honeycomb structure portion comprises ceramics having an NTC property and the pair of electrode layers comprise a material having the PTC property, so that a decrease in electrical resistance upon an increase in a temperature can be reduced, a constant power can easily be applied over time, and a rapidly increase in the temperature can be suppressed.

### BRIEF DESCRIPTION OF THE DRAWINGS

FIG. 1 is a schematic external view of a honeycomb structure according to an embodiment of the present invention; and

FIG. 2 is a schematic cross-sectional view of a pair of electrode layers provided on a honeycomb structure portion of an electrically heating support according to an embodiment of the present invention and electrode terminals provided on the pair of electrode layers, which is perpendicular to an extending direction of cells.

### DETAILED DESCRIPTION OF THE INVENTION

Hereinafter, embodiments of a honeycomb structure, an electrically heating support, and an exhaust gas purifying device according to the present invention will be described with reference to the drawings. However, the present invention should not be interpreted as being limited to those embodiments, and various changes, modifications and improvements may be made based on the knowledge of one of ordinary skill in the art without departing from the scope of the invention.

### <Honeycomb Structure and Electrically Heating Support>

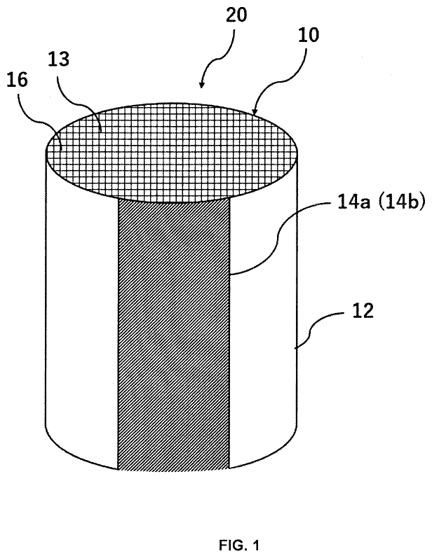

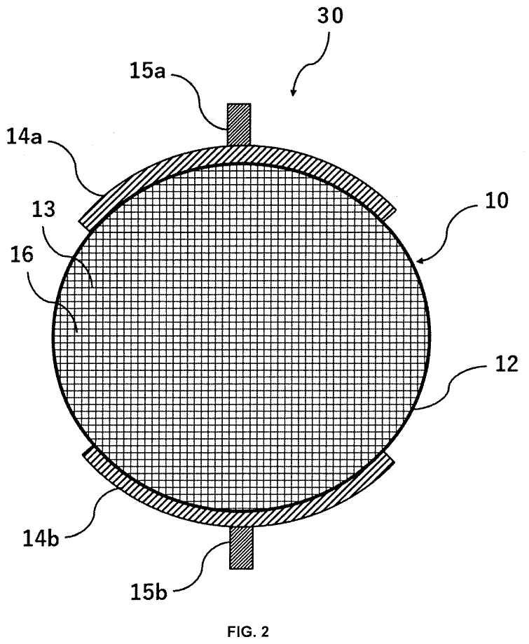

FIG. 1 is a schematic external view of a honeycomb structure 20 according to an embodiment of the present invention. FIG. 2 is a schematic cross-sectional view of a pair of electrode layers 14a , 14b provided on a honeycomb structure portion 10 of an electrically heating support 30 according to an embodiment of the present invention and electrode terminals 15a , 15b provided on the pair of electrode layers 14a , 14b , which is perpendicular to an extending direction of cells 16.

### (1. Honeycomb Structure)

The honeycomb structure 20 includes the honeycomb structure portion 10 and a pair of electrode layers 14a , 14b . The honeycomb structure 10 portion is a pillar shaped member made of ceramics, and has an outer peripheral wall 12 and a partition wall 13 that is arranged on an inner side of the outer peripheral wall 12 and defines a plurality of cells 16 each extending from one end face to the other end face to form a flow path. It is understood that the pillar shape is a three-dimensional shape having a thickness in an extending direction of the cells 16 (axial direction of the honeycomb structure portion 10). A ratio of an axial length of the honeycomb structure portion 10 to a diameter or width of the end face of the honeycomb structure portion 10 (aspect ratio) is arbitrary. The pillar shape may also include a shape in which the axial length of the honeycomb structure portion 10 is shorter than the diameter or width of the end face (flat shape).

An outer shape of the honeycomb structure portion 10 is not particularly limited as long as it has a pillar shape. For example, it can be other shapes such as a pillar shape having circular end faces (cylindrical shape), a pillar shape having oval end faces, and a pillar shape having polygonal (rectangular, pentagonal, hexagonal, heptagonal, octagonal, etc.) end faces. As for the size of the honeycomb structure portion 10, an area of the end faces is preferably from 2,000 mm² to 20,000 mm², and even more preferably from 5,000 mm² to 15,000 mm², in order to increase heat resistance (to suppress cracks generated in the circumferential direction of the outer peripheral wall).

A shape of each cell in the cross section perpendicular to the extending direction of the cells 16 may preferably be a quadrangle, hexagon, octagon, or a combination thereof, although not limited thereto. Among these, the quadrangle and the hexagon are preferred, because they can lead to a decreased pressure loss upon flowing of an exhaust gas through the honeycomb structure portion 10 when the honeycomb structure portion 10 is used as a catalyst support and a catalyst is supported thereon, thereby providing improved purification performance. The hexagon is even more preferable from the viewpoint that the purification performance of the catalyst can be more improved.

The partition wall 13 that defines the cells 16 preferably has a thickness of from 0.1 mm to 0.3 mm, and more preferably from 0.1 mm to 0.2 mm. The thickness of 0.1 mm or more of the partition wall 13 can suppress a decrease in the strength of the honeycomb structure portion 10. The thickness of the partition wall 13 of 0.3 mm or less can suppress a larger pressure loss when an exhaust gas flows through the honeycomb structure portion 10 if the honeycomb structure portion 10 is used as a catalyst support and a catalyst is supported thereon. In the present invention, the thickness of the partition wall 13 is defined as a length of a portion passing through the partition wall 13, among line segments connecting the centers of gravity of adjacent cells 16, in the cross section perpendicular to the extending direction of the cells 16.

The honeycomb structure portion 10 preferably has a cell density of from 40 cells/cm² to 150 cells/cm², and more preferably from 70 cells/cm² to 100 cells/cm², in the cross section perpendicular to the extending direction of the cells 16. The cell density in such a range can allow the purification performance of the catalyst to be increased while reducing the pressure loss when the exhaust gas flows. The cell density of 40 cells/cm² or more can allow a catalyst support area to be sufficiently ensured. The cell density of 150 cells/cm² or less can prevent the pressure loss when the exhaust gas flows through the honeycomb structure portion 10 from being increased if the honeycomb structure portion 10 is used as a catalyst support to support the catalyst. The cell density is a value obtained by dividing the number of cells by the area of one end face portion of the honeycomb structure portion 10 excluding the outer peripheral wall 12 portion.

The provision of the outer peripheral wall 12 of the honeycomb structure portion 10 is useful from the viewpoints of ensuring the structural strength of the honeycomb structure portion 10 and suppressing the leakage of the fluid flowing through the cells 16 from the outer peripheral wall 12. Specifically, the thickness of the outer peripheral wall 12 is preferably 0.05 mm or more, and more preferably 0.10 mm or more, and even more preferably 0.15 mm or more. However, if the outer peripheral wall 12 is too thick, the strength will be too high, and a strength balance between the outer peripheral wall 12 and the partition wall 13 will be lost, resulting in a decrease in thermal shock resistance. Therefore, the thickness of the outer peripheral wall 12 is preferably 1.0 mm or less, and more preferably 0.7 mm or less, and even more preferably 0.5 mm or less. The thickness of the outer peripheral wall 12 is defined as a thickness of the outer peripheral wall 12 in the normal line direction relative to the tangent line at a measured point when the point of the outer peripheral wall 12 where the thickness is to be measured is observed in the cross section perpendicular to the extending direction of the cells.

The honeycomb structure portion 10 has electrical conductivity. Volume resistivity is not particularly limited as long as the honeycomb structure portion 10 is capable of heat generation by Joule heat when a current is applied. Preferably, the volume resistivity is from 0.1 Ω·cm to 200 Ω·cm, and more preferably from 1 Ω·cm to 200 Ω·cm. As used herein, the volume resistivity of the honeycomb structure portion 10 refers to a value measured at 25° C. by the four-terminal method.

The honeycomb structure 10 is comprised of ceramics having an NTC property (property in which electrical resistance decreases as temperature increases). The expression “having an NTC property” means, for example, that a rate of an increase in electrical resistance of the honeycomb structure portion as described below indicates a negative value, and so on. The honeycomb structure portion 10 can be made of a material selected from non-oxide ceramics such as silicon carbide, silicon nitride and aluminum nitride, although not limited thereto. Further, silicon carbide-metal-silicon composites and silicon carbide/graphite composites can also be used. Among these, it is preferable that the material of the honeycomb structure portion 10 contains ceramics mainly based on a silicon-silicon carbide composite material or silicon carbide, in terms of balancing heat resistance and electrical conductivity. The phrase “the material of the honeycomb structure portion 10 is mainly based on silicon-silicon carbide composite material” means that the honeycomb structure portion 10 contains 90% by mass of more of silicon-silicon carbide composite material (total mass) based on the total material. Here, the silicon-silicon carbide composite material contains silicon carbide particles as an aggregate and silicon as a binding material to bind the silicon carbide particles, preferably in which a plurality of silicon carbide particles are bound by silicon such that pores are formed between the silicon carbide particles. The phrase “the material of the honeycomb structure portion 10 is mainly based on silicon carbide” means that the honeycomb structure portion 10 contains 90% or more of silicon carbide (total mass) based on the total material.

It is preferable that a rate of an increase in electrical resistivity of the honeycomb structure portion 10 is from −80% to −10%. The rate of the increase in electrical resistivity of the honeycomb structure portion 10 can be determined by measuring volume resistivities (Ω·cm) at two points at 50° C. and 500° C. using the four-terminal method, subtracting the volume resistivity at 50° C. from the volume resistivity at 500° C., dividing the derived value by the volume resistivity at 50° C., and multiplying the resulting value by 100. The rate of the increase in electrical resistance of −80% or more can decrease a change in electrical resistance during current conduction heating, thereby making it easier to apply a constant electric power over time during current conduction. When the rate of the increase in electrical resistance of the honeycomb structure section 10 is −10% or less, the honeycomb structure portion 10 indicates the NTC property, and ceramics mainly based on silicon-silicon carbide composite or silicon carbide can be used for the honeycomb structure portion 10. The rate of the increase in electrical resistance of the honeycomb structure portion 10 is more preferably from −70% to −20%, and even more preferably from −70% to −30%.

It is preferable that the porosity of the honeycomb structure portion 10 is higher than that of the pair of electrode layers 14a ,14b . If the porosity satisfies this relationship, a catalyst is easily supported on the honeycomb structure portion 10 having higher porosity and the catalyst is not easily supported on the pair of electrode layers 14a , 14b having lower porosity when the honeycomb structure 20 is used as a catalyst support and a catalyst is supported thereon. As a result, the catalyst can be efficiently supported on the honeycomb structure portion 10 through which the exhaust gas passes, and the purification performance of the catalyst tends to be improved. The porosity of the honeycomb structure portion 10 is preferably from 35% to 60%, and more preferably from 35% to 45%. The porosity is a value measured by a mercury porosimeter.

The honeycomb structure portion 10 preferably has a thermal expansion coefficient of from 4.0 ppm/K to 4.75 ppm/K, and more preferably from 4.0 ppm/K to 4.6 ppm/K. The thermal expansion coefficient refers to a linear thermal expansion coefficient at a temperature of from 40° C. to 800° C., measured by a method in accordance with JIS R 1618: 2002. As a thermal expansion meter, “TD 5000 S (trade name)” from BrukerAXS can be used.

### (2. Electrode Layer)

The honeycomb structure 20 is provided with a pair of electrode layers 14a , 14b on a surface of the outer peripheral wall 12, so as to face each other across a central axis of the honeycomb structure portion 10. The pair of electrode layers 14a , 14b are comprised of ceramics having a PTC property (property in which electrical resistance decreases as a temperature increases). The expression “having an PTC property” means, for example, that a rate of an increase in electrical resistance of the pair of electrode layers as described below indicates a negative value, and so on.

In the honeycomb structure 20 and the electrically heating support 30 according to the embodiment of the present invention, the honeycomb structure portion 10 is composed of the ceramics having the NTC property and the pair of electrode layers 14a , 14b are composed of the material having the PTC property, so that the electrical resistance between the honeycomb structure portion 10 and each of the pair of electrode layers 14a , 14b can be adjusted to control a balance of the electrical resistance of the entire electrically heating support, thereby obtaining the honeycomb structure 20 and the electrically heating support 30 that can easily apply the constant power to the electrically heating support over time.

It is preferable that the thermal expansion coefficient of each of the pair of electrode layers 14a , 14b is higher than that of the honeycomb structure portion 10. The thermal expansion coefficient satisfying this relationship decreases a difference between the thermal expansion coefficients of each of the pair of electrode layers 14a , 14b and each of electrode terminals 15a , 15b when the electrode terminals 15a , 15b are arranged on the pair of electrode layers 14a , 14b , respectively, to provide an electrically heating support 30, thereby resulting in the electrically heating support 30 having improved thermal shock resistance. The thermal expansion coefficient of each of the pair of electrode layers 14a , 14b is preferably from 4.5 ppm/K to 10 ppm/K, and more preferably from 4.5 ppm/K to 7 ppm/K. The thermal expansion coefficient of each of the electrode layer 14a , 14b can be measured by the same method as that for measuring the thermal expansion coefficient of the honeycomb structure portion 10 described above.

It is preferable that a rate of an increase in electrical resistivity of each of the pair of electrode layers 14a , 14b is from 2% to 40%. The rate of the increase in electrical resistivity of each of the pair of electrode layers 14a , 14b can be determined by measuring volume resistivities (Ω·cm) at two points at 50° C. and 500° C. using the four-terminal method, subtracting the volume resistivity at 50° C. from the volume resistivity at 500° C., dividing the derived value by the volume resistivity at 50° C., and multiplying the resulting value by 100, as with the rate of the increase in electrical resistivity of the honeycomb structure portion 10 as described above. The rate of the increase in electrical resistance of 2% or more can increase electrical resistance of the pair of electrode layers 14a , 14b during current conduction heating and compensate for a decrease in electrical resistance during current conduction heating by the NTC property of the honeycomb structure portion 10, thereby making it easier to apply the constant electric power over time. The rate of the increase in electrical resistance of the pair of electrode layers 14a , 14b of 40% or less can reduce Joule heating due to the increase in resistance of the pair of electrode layers 14a , 14b during current conduction heating. The rate of the increase in electrical resistance of each of the pair of electrode layers 14a , 14b is more preferably from 5% to 30%, and even more preferably from 10% to 30%.

The pair of electrode layers 14a , 14b can be made of a metal or a mixture of a metal compound with oxide ceramics. The metal may be a single metal or an alloy, including silicon, aluminum, iron, stainless steel, titanium, tungsten, Ni—Cr alloys, and the like. The metal compound may be a material other than oxide ceramics, including metal oxides, metal nitrides, metal carbides, metal silicides, metal borides, and composite oxides. The single metal or metal compound can be used alone, or in combination with two or more. The oxide ceramics include glass, cordierite, and mullite. The oxide ceramics can be used alone or in combination with two or more. Among them, the mixtures containing at least stainless steel and glass are more preferable because their electrical resistance can be easily adjusted and their durability is superior.

The material of each of the pair of electrode layers 14a , 14b may be a mixture of carbon and ceramics. The ceramics include glass, cordierite, mullite, silicon carbide, silicon nitride, zirconia, and others. The ceramics can be used alone, or in combination with two or more.

Although there are no particular restrictions on the forming regions of the pair of electrode layers 14a , 14b , it is preferable that each of the electrode layer 14a , 14b are provided so as to extend in a band shape in the circumferential direction of the outer peripheral wall 12 and in the extending direction of the cells on the outer surface of the outer peripheral wall 12, in view of improvement of uniform heat generation of the honeycomb structure portion 10. More particularly, each of the pair of electrode layers 14a , 14b preferably extends over 80% or more of the length between both end faces of the honeycomb structure portion 10, more preferably over 90% or more of the length, even more preferably over the entire length, from the viewpoint that the current can easily spread in the axial direction of the pair of electrode layers 14a , 14b . By forming the pair of electrode layers 14a , 14b in such a band shape, it is easier to suppress a rapid temperature increase. This would be because if the electrical resistance decreases at a part of the honeycomb structure portion 10 having the NTC property and a temperature of that part locally increases, a temperature of a part of the electrode layers 14a , 14b close to that part of the honeycomb structure portion 10 increases, and the electrical resistance increases. As a result, the current flows to the electrode layers 14a , 14b other than the part of the electrode layers 14a , 14b whose electrical resistance has increased, and the current then flow to the honeycomb structure portion 10, so that the temperature of the entire honeycomb structure portion 10 would be equalized.

Each of the pair of electrode layers 14a , 14b has a thickness of from 0.01 mm to 5 mm, and more preferably from 0.01 mm to 3 mm. Such a range of the thickness can lead to improvement of uniform heat generation. The thickness of each of the electrode layer 14a , 14b of 0.01 mm or more can lead to proper control of the electrical resistance, thereby generating heat more uniformly. The thickness of 5 mm or less reduces a risk of damage during canning. The thickness of each of the pair of electrode layers 14a , 14b is defined as a thickness of an outer surface of each of the pair of electrode layers 14a , 14b in a normal direction relative to a tangent line at a point where the thickness is to be measured, when the point to be measured for each of the pair of electrode layers 14a , 14b is observed in the cross section perpendicular to the extending direction of the cells.

(3. Electrode Terminal)

Each of the electrode terminals 15a , and 15b may be formed in a pillar shape or may be branched into a plurality of comb-like shapes, each of which has a contact point for connecting to each of the pair of electrode layers 14a , 14b . The electrode terminals 15a , 15b are arranged on and electrically connected to the pair of electrode layers 14a , 14b , respectively. As a result, when a voltage is applied to the electrode terminals 15a , 15b , an electric current can be conducted to heat the honeycomb structure portion 10 by Joule heat. Therefore, the honeycomb structure portion 10 can be suitably used as a heater. The voltage to be applied is preferably from 12 V to 900 V, and more preferably from 48 V to 600 V, although the voltage to be applied may be changed as needed.

The electrode terminals 15a , 15b may be made of a metal. Although single metals and alloys may be used as the metal, it is preferable to use alloys containing at least one selected from the group consisting of Cr, Fe, Co, Ni, and Ti, for example, in terms of corrosion resistance, volume resistivity, and linear expansion coefficient, and it is more preferable to use stainless steel and Fe-Ni alloys. The shape and size of each of the electrode terminals 15a , 15b are not particularly limited, and they can be designed according to the size and current conduction performance of the electrically heating support.

The electrode terminals 15a , 15b may be composed of ceramics. The ceramics include, but not limited to, silicon carbide (SiC), metal compounds such as metal silicides such as tantalum silicide (TaSi₂) and chromium silicide (CrSi₂), and composites containing one or more metals (cermet). Specific examples of cermet include composites of silicon and silicon carbide; composites of metal silicides such as tantalum silicide and chromium silicide, and metal silicon, and silicon carbide; as well as composites obtained by adding one or more insulating ceramics such as alumina, mullite, zirconia, cordierite, silicon nitride, and aluminum nitride to one or more of the above metals in terms of reducing thermal expansion. The material of each of the electrode terminals 15a , 15b may be of the same quality as that of each of the pair of electrode layers.

If the electrode terminals 15a , 15b are made of ceramics, each of tips of them may be joined to a metal terminal. The ceramic terminals and the metal terminals can be joined by means of clamping, welding, conductive adhesives, or the like. The material of the metal terminals includes conductive metals such as iron alloys and nickel alloys.

By supporting a catalyst on the electrically heating support 30, the electrically heating support 30 can be used as a catalyst body. A fluid such as an exhaust gas from a motor vehicle can flow through the flow paths of the cells 16. Examples of the catalyst include noble metal-based catalysts and catalysts other than those. Illustrative examples of the noble metal catalysts include three-way catalysts and oxidation catalysts having a noble metal such as platinum (Pt), palladium (Pd), and rhodium (Rh) supported on surfaces of alumina pores, and containing a co-catalyst such as ceria and zirconia; or lean NOx trap catalysts (LNT catalysts) containing an alkaline earth metal and platinum as storage components for nitrogen oxides (NOx). Examples of catalysts that do not use noble metals include NOx catalytic reduction catalysts (SCR catalysts) containing copper-substituted or iron-substituted zeolites, and the like. Further, two or more types of catalysts selected from the group consisting of those catalysts may be used. A method of supporting the catalyst is also not particularly limited, and it can be carried out according to the conventional method of supporting the catalyst on the honeycomb structure.

### <Method for Producing Electrically Heating Support>

Next, a method for producing an electrically heating support is described by way of example. In an embodiment where the electrode terminals are made of ceramics, the method for producing the electrically heating support includes: a step A1 of obtaining an unfired honeycomb structure with electrode terminal forming pastes; and a step A2 of firing the unfired honeycomb structure with electrode terminal forming pastes to obtain a honeycomb structure with electrode terminals. In other embodiments, electrode layer forming pastes and electrode terminal forming pastes may be calcined and then attached to the honeycomb structure. In an embodiment where the electrode terminals are made of the metal, the method includes: a step of obtaining an unfired honeycomb structure with electrode layer forming pastes, and then firing the unfired honeycomb structure with electrode layer forming pastes to obtain a honeycomb structure; and a step of fixing metal electrode terminals to the pair of electrode layers of the honeycomb structure, respectively.

The step A1 is to produce a pillar shaped honeycomb formed body which is a precursor of the honeycomb structure, applying electrode layer forming pastes to a side surface of the pillar shaped honeycomb formed body to obtain an unfired honeycomb structure with electrode layer forming pastes, and then providing electrode terminal forming pastes on the electrode layer forming pastes to obtain an unfired honeycomb structure with electrode terminal forming pastes.

To produce the pillar shaped honeycomb formed body, first, a forming raw material is prepared by adding to silicon carbide powder (silicon carbide), metal silicon powder (metal silicon), a binder(s), a surfactant(s), a pore former, water and the like. The addition is preferably such that a mass of the metal silicon powder is from 10% to 40% of the total mass of the silicon carbide powder and the metal silicon powder. An average particle diameter of silicon carbide particles in the silicon carbide powder (silicon carbide) is preferably from 3 μm to 50 μm, and more preferably from 3 μm to 40 μm. An average particle diameter of metal silicon particles in the metal silicon powder (metal silicon) is preferably from 2 μm to 35 μm. The average particle diameter of each of the silicon carbide particles and the metal silicon particles refers to an arithmetic average diameter on a volume basis when frequency distribution of particle diameters is measured by the laser diffraction method.

Examples of the binder include methyl cellulose, hydroxypropylmethyl cellulose, hydroxypropoxyl cellulose, hydroxyethyl cellulose, carboxymethyl cellulose, and polyvinyl alcohol. Among them, it is preferable to use methyl cellulose in combination with hydroxypropoxyl cellulose. A content of the binder is preferably from 2.0 parts to 10.0 parts by mass when the total mass of the silicon carbide powder and the metal silicon powder is 100 parts by mass.

A content of water is preferably from 20 parts to 60 parts by mass when the total mass of the silicon carbide powder and the metal silicon powder is 100 parts by mass.

The surfactant that can be used herein include ethylene glycol, dextrin, fatty acid soaps, and polyalcohol, and the like. These may be used alone or in combination of two or more. A content of the surfactant is preferably from 0.1 parts to 2.0 parts by mass when the total mass of the silicon carbide powder and the metal silicon powder is 100 parts by mass.

The pore former is not particularly limited as long as it forms pores after firing. Examples of the pore former include graphite, starch, foamed resins, water-absorbent resins, silica gel, and the like. A content of the pore former is preferably from 0.5 parts to 10.0 parts by mass when the total mass of the silicon carbide powder and the metal silicon powder is 100 parts by mass. An average particle diameter of the pore former is preferably from 10 μm to 30 μm. The average particle diameter of the pore former refers to an arithmetic average diameter on a volume basis when frequency distribution of particle diameters is measured by the laser diffraction method. If the pore former is the water-absorbent resin, the average particle diameter of the pore former refers to an average particle diameter after water absorption.

The resulting forming raw material is then kneaded to form a green body, and the green body is then extruded to produce a pillar shaped honeycomb formed body. For the extrusion, a die having a desired overall shape, cell shape, wall thickness, cell density, and the like can be used. Subsequently, the resulting pillar shaped honeycomb formed body is preferably dried. If the length of the pillar shaped honeycomb formed body in the direction of the central axis is not the desired length, both end faces of the pillar shaped honeycomb formed body can be cut to have the desired length. The pillar shaped honeycomb formed body after drying is called a pillar shaped honeycomb dried body.

Subsequently, an electrode layer forming paste is prepared in order to form the pair of electrode layers. The electrode layer forming paste can be formed by adding various additives to the raw material powder (metal powder, glass powder, and the like) formulated according to required characteristics of the pair of electrode layers, and kneading them. Powder of a metal such as stainless steel can be used as the metal powder.

The resulting electrode layer forming paste is applied to the side surface of the pillar shaped honeycomb formed body (typically the pillar shaped honeycomb dried body) to obtain an unfired honeycomb structure with electrode layer forming pastes. The applying of the electrode layer forming paste to the pillar shaped honeycomb formed body can be carried out in accordance with the known method for producing a honeycomb structure.

As a variation of the method for producing the honeycomb structure, the pillar shaped honeycomb formed body may be fired before applying the electrode layer forming paste in the step A1. That is, in this variation, the pillar shaped honeycomb formed body is fired to produce a pillar shaped honeycomb fired body, and the electrode layer forming paste is applied to the pillar shaped honeycomb fired body.

Next, if the electrode terminals are made of ceramics, an electrode terminal forming paste is prepared in order to form the electrode terminals. The electrode terminal forming paste can be formed by mixing various additives with ceramic powder formulated according to required characteristics of the electrode terminals. The prepared electrode terminal forming paste is then provided on the surface of the pair of electrode layers on the pillar shaped honeycomb structure.

In the step A2, the unfired honeycomb structure with electrode terminal forming pastes is fired to obtain a honeycomb structure with electrode terminals. The filing can be carried out under conditions: in an inert gas atmosphere or an air atmosphere, at an atmospheric pressure or less, at a firing temperature of from 1150° C. to 1350° C., for a firing time of from 0.1 hours to 50 hours. The firing atmosphere can be, for example, an inert gas atmosphere, and the pressure during firing can be ambient pressure. In order to decrease the electrical resistance of the honeycomb structure portion 10, it is preferable to decrease the residual oxygen in terms of inhibited oxidation, and it is preferable to create a high vacuum of 1.0×10⁻⁴ Pa or more in the atmosphere during sintering and then purge the inert gas before sintering. The inert gas atmosphere includes a N₂ gas atmosphere, a helium gas atmosphere, an argon gas atmosphere, and the like. Before firing, the unfired honeycomb structure with electrode terminal forming pastes may be dried. Further, prior to the firing, degreasing may also be carried out to remove the binder and the like. The electrically heating support with the electrode terminals electrically connected to the pair of electrode layers is thus obtained.

When metal terminals are used as the electrode terminals, the metal terminals are fixed onto the pair of electrode layers of the honeycomb structure 20. The method for fixing them includes, for example, laser welding, thermal spraying, ultrasonic welding, and the like.

### <Exhaust Gas Purifying Device>

The electrically heating support according to each of the above embodiments of the present invention can be used in an exhaust gas purifying device. The exhaust gas purifying device includes the electrically heating support and a can body for holding the electrically heating support. In the exhaust gas purifying device, the electrically heating support is installed in the middle of an exhaust gas flow path for an exhaust gas from an engine. The can body used herein can be a metal cylindrical member or the like that holds the electrically heating support.

### DESCRIPTION OF REFERENCE NUMERALS

10 honeycomb structure portion
12 outer peripheral wall
13 partition wall
14a , 14b electrode layer
15a , 15b electrode terminal
16 cell
20 honeycomb structure
30 electrically heating support

1. A honeycomb structure, comprising:
a honeycomb structure portion including: an outer peripheral wall; a partition wall arranged on an inner side of the outer peripheral wall, the partition wall defining a plurality of cells each extending from one end face to other end face to form a flow path; and
a pair of electrode layers arranged on a surface of the outer peripheral wall of the honeycomb structure portion, the pair of electrode layers being provided so as to face each other across a central axis of the honeycomb structure portion,
wherein the honeycomb structure portion comprises ceramics having an NTC property, and the pair of electrode layers comprise a material having a PTC property.

2. The honeycomb structure according to claim 1, wherein the honeycomb structure portion has a porosity higher than that of each of the pair of electrode layers.

3. The honeycomb structure according to claim 1, wherein each of the pair of electrode layers is provided so as to extend in an extending direction of the cells on an outer surface of the outer peripheral wall.

4. The honeycomb structure according to claim 1, wherein a rate of an increase in electrical resistance of the honeycomb structure portion is from −80% to −10%.

5. The honeycomb structure according to claim 1, wherein each of the pair of electrode layers has a thermal expansion coefficient higher than that of the honeycomb structure portion.

6. The honeycomb structure according to claim 1, wherein a rate of an increase in electrical resistance of each of the pair of electrode layers is from 2% to 40%.

7. The honeycomb structure according to claim 1, wherein the pair of electrode layers are made of a metal or a mixture of a metal compound and oxide ceramics.

8. The honeycomb structure according to claim 1, wherein the pair of electrode layers are made of a mixture of carbon and ceramics.

9. An electrically heating support, comprising:
the honeycomb structure according to claim 1; and
electrode terminals electrically connected onto the pair of electrode layers of the honeycomb structure.

10. An exhaust gas purifying device, comprising:
the electrically heating support according to claim 9; and
a can body for holding the electrically heating support.
